(19) United States
(12) Patent Application Publication
(10) Pub. No.: US 2007/0214502 A1
(43) Pub. Date: Sep. 13, 2007

(54) Technique for processing data packets in a communication network

(76) Inventor: Donald K. McAlister, Apex, NC (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/699,765

(22) Filed: Jan. 30, 2007

Related U.S. Application Data
(60) Provisional application No. 60/780,444, filed on Mar. 8, 2006.

(51) Int. Cl. G06F 15/16

(52) U.S. Cl. 726/15

(57) ABSTRACT

A technique for processing secure data packets that are directly and not directly addressed to a policy enforcement point (PEP). The present invention incorporates a dual internal path for the fast path processing of secure data packets at a PEP. A first path is used to process secure data packets addressed to the PEP. A second path is used to process secure data packets not addressed to the PEP. On the first path, secure data packets addressed to the PEP are transferred to the PEP for immediate processing. On the second path, a series of checks are performed to maximize the speed of processing the secure data packets. In addition, policies associated with the secure data packets are retrieved and destination address/mask combinations are used along with destination addresses in the secure data packets to determine if the packets are to be further processed or dropped.

### RELATED APPLICATION

This application claims the benefit of U.S. Provisional Application No. 60/780,444. filed Mar. 8, 2006, the entire teachings of which are incorporated herein by reference.

### FIELD OF THE INVENTION

The present invention relates to processing data packets in a communication network.

### BACKGROUND OF THE INVENTION

A communication network is a geographically distributed collection of nodes interconnected by communication links and segments for transporting communications (e.g., data) between communication units (end nodes), such as personal computers, certain telephones, personal digital assistants (PDAs), video units and the like. Many types of communication networks are available, with the types ranging from local area networks (LANs) to wide area networks (WANs). LANs typically connect nodes over dedicated private communications links located in the same general physical location, such as a building or campus. WANs, on the other hand, typically connect large numbers of geographically dispersed nodes over long-distance communications links, such as common carrier communication lines. The Internet is an example of a WAN that connects networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other.

Often data transferred in communication networks are sent unsecured without the benefit of encryption and/or strong authentication of the sender. Sending unsecured data on a communication network may make the data vulnerable to being intercepted, inspected, modified and/or redirected. To make data less prone to these vulnerabilities, many networks employ various security standards and protocols to secure network traffic transferred in their networks. This secured network traffic is typically transferred in the network in secure data packets that are encoded according to a security standard and/or protocol. As used herein, a secure data packet is a data packet that has been secured using a security standard and/or protocol (e.g., the IPsec standard). Likewise, as used herein, an unsecured data packet is a data packet that has not been secured using a security standard and/or protocol.

One well-known widely-used standard for securing IP traffic is the IP security (IPsec) standard. The IPsec standard comprises a collection of protocols that may be used to transfer secure data packets in a communication network. IPsec operates at layer-3 (L3) which is the network layer of the Open Systems Interconnection Reference Model (OSI-RM). A description of IPsec may be found in Request for Comments (RFC) 2401 through RFC 2412 and RFC 4301 through RFC 4309 all of which are available from the Internet Engineering Task Force (IETF). Two cryptographic protocols that are commonly used to encapsulate IPsec packets are the Authentication Header (AH) protocol and the Encapsulating Security Payload (ESP) protocol.

The AH protocol is primarily used to provide connectioness integrity and authentication of IP datagram traffic. The authentication enables the origin of the traffic to be verified and ensure that the traffic has not been altered in transit. Authentication and integrity of an IP packet is achieved using a keyed one-way hash function, such as Message Digest algorithm 5 (MD5) or Secure Hash Algorithm-1 (SHA-1), in combination with a secret that is shared between a sender of the packet and a receiver of the packet.

Specifically, the one-way hash function along with the secret is applied to the packet to produce a message digest by the sender. The sender places the digest in the packet as an Integrity Check Value (ICV) for the packet. The receiver performs the same one-way hash function on the packet using the shared secret and compares the result with the ICV contained in the packet. If the two are the same, the receiver can reasonably conclude that the packet is authentic and its integrity has been upheld in transit (e.g., the packet has not changed in transit). If the two differ, the receiver can conclude the packet is not authentic and/or the integrity of the packet has been breached (e.g., the data in the packet has changed in transit) and deal with it accordingly (e.g., drop the packet).

Like the AH protocol, the ESP protocol provides a means to authenticate and verify the integrity of IP traffic carried in a secured packet. In addition, the ESP protocol provides a means to encrypt the IP traffic to prevent unauthorized interception of the IP traffic. Like the AH protocol, the ESP uses an ICV to authenticate and check the integrity of a packet. Encryption is used to secure the IP traffic. Encryption is accomplished by applying an encryption algorithm to the IP traffic to encrypt it. Encryption algothrims commonly used with IPsec include Data Encryption Standard (DES), triple-DES and Advanced Encryption Standard (AES).

IPsec defines a transport mode and a tunnel mode which may be used to transport packets in a communication network. Transport mode is used to transport non-tunneled packets through a communication network. Transport mode typically involves incorporating an AH or ESP header into the packets and transporting the packets in the network using the original header of the packets. Tunnel mode is used to transport tunneled packets through a communication network. Here, an original packet is encapsulated within an IP packet which contains an outer IP header that is used to transport the IP packet over the network via the tunnel.

Packets transferred in a network using the IPsec tunnel mode typically travel on a tunnel that is established between two endpoints. The endpoints are commonly referred to as policy enforcement points (PEPs). Here, original packets are encapsulated and optionally encrypted at a first PEP located at one endpoint of the tunnel to produce IPsec packets. As used herein, an IPsec packet is a packet that is encoded in accordance with the IPsec standard. The IPsec packets are transferred via the tunnel from the first PEP to a second PEP located at the other endpoint of the tunnel. The second PEP unencapsulates and decrypts the IPsec packets, as necessary, to reveal the original packets. The original packets may then be further processed by the second PEP which may include forwarding the original packets to their destination.

In IPsec, a security association relates to a simplex “connection” that affords security services to the traffic carried by the “connection.” The set of security services offered by a security association depends on the security protocol selected, the security association mode, the endpoints of the security association and the election of optional services within the protocol. For example, AH typically provides data origin authentication and connectionless integrity for IP datagrams. ESP optionally provides confidentiality of traffic, the strength of which depends in part, on the encryption algorithm employed. ESP also may optionally provide authentication. The scope of the authentication offered by ESP is typically narrower than for AH (e.g., IP headers “outside” an ESP header contained in ESP encoded IPsec packet are not protected).

### SUMMARY OF THE INVENTION

Internet Protocol security (Ipsec) tunnel mode generally assumes that secure packets are being transported only between two endpoints, such as, e.g., policy enforcement points (PEPs). This poses a problem when secure packets need to be broadcast/multicast to several endpoints. Several techniques have been proposed to overcome this shortcoming. One such technique is described in commonly-owned U.S. Provisional Application No. 60/756,765, titled “Securing Network Traffic Using Distributed Key Generation and Dissemination Over Secure Tunnels.” Here, an IP packet's original IP header containing a multicast/broadcast destination address is copied to the outer header of an IPsec packet used to encapsulate the IP packet. Copying the original IP header to the outer header causes the IPsec packet to be treated as a multicast/broadcast packet when routed through the network.

One problem with using the above-described technique to broadcast/multicast secure packets in a communication network is that the PEPs of an IPsec tunnel may inadvertently drop the secure packets or pass the secure packets “in the clear” because the PEPs may be configured to drop or pass “in the clear” traffic that is not addressed to the PEPs. Dropping a packet may cause problems for a connection (e.g., TCP connections) associated with the packet. Moreover, passing a secure packet “in the clear” may cause problems when the packet is received and processed at its destination because the destination may not expect to receive the secured packet.

The present invention overcomes these shortcomings by providing a technique for processing secure data packets that are either directly or not directly addressed to a PEP. In accordance with an aspect of the invention, a dual internal path, comprising a first path and a second path, is used to accommodate the fast path processing of secure data packets at a PEP. The first path is used to process secure data packets addressed to the PEP. The second path is used to process secure data packets not addressed to the PEP.

In one embodiment, the invention is a method for processing data packets. The method comprising the steps of receiving a first frame at a secure gateway (SGW) of a communication network, identifying a policy associated with the data packet using the information on the first network header portion and on the first transport layer header portion, determining a mode of transmitting the data packet to a destination in accordance with the entry, and encrypting the data packet if the mode of transmitting requires for the data packet to be secured using a security standard and/or protocol. The first frame can contain a data packet, a first network header portion and a first transport layer header portion.

In another embodiment, the invention includes a method for processing data packets. The method comprises the steps of receiving a frame having a secure data packet at a secure gateway of a communication network, incorporating a dual internal path at the secure gateway for processing the secure data packet, and using the information on the outer header portion to identify a policy associated with the secure data packet, the policy indicating a range of addresses. The secure data packet contains an encrypted inner data packet and an outer header portion. In the step of incorporating a dual internal path at the secure gateway, the secure data packet is routed through a first path or a second path of the dual internal path at the secure gateway

On the first path, secure data packets addressed to the PEP are transferred to the PEP for immediate processing. On the second path, a series of checks are performed to maximize the speed of processing the secure data packets. In addition, policies associated with the secure data packets are retrieved and destination address/mask combinations are used along with destination addresses in the secure data packets to determine if the packets are to be further processed or dropped.

In an embodiment of the invention, a secure data packet containing a security parameters index (SPI) and a destination address is received from by a SGW in a communication network. The destination address is checked to determine if the secure data packet is addressed to the SGW. If so, the secure data packet is processed by the SGW as a normal secure data packet. If the secure data packet is not addressed to the SGW, the SPI is used to retrieve a policy associated with the secure data packet that specifies a range of addresses associated with the policy. The destination address contained in the secure data packet is compared with the range of addresses specified by the policy to determine if they match. If so, the secure data packet is further processed by the SGW and treated as a normal secure data packet. This processing may include decrypting an encrypted inner data packet contained in the secure data packet as well as authenticating the decrypted inner data packet.

One embodiment of the invention is a SGW in a communication network previously described. This SGW comprises a module receiving a frame at a SGW of a communication network. The frame containing a data packet, a network header portion and a first transport layer header portion. The SGW further comprises a processor for identifying a policy associated with the data packet using the information on the first network header portion and on the first transport layer header portion, for determining a mode of transmitting the data packet to a destination in accordance with the entry and for encrypting the data packet if the mode of transmitting requires for the data packet to be secured using a security standard and/or protocol.

One embodiment of the invention is also another version of the SGW in a communication network. This SGW comprises a module receiving a frame having a secure data packet, which contains an encrypted inner data packet and an outer header portion, at the SGW of a communication network. The SGW further comprises a processor for incorporating a dual internal path at the SGW for processing the secure data packet. The secure data packet can be routed through a first path or a second path of the dual internal path at the SGW. Here, The processor is further configured to use the information on the outer header portion to identify a policy, which indicates a range of addresses, associated with the secure data packet.

Another embodiment of the invention is a computer readable medium having computer readable program codes embodied therein for processing data packets. The computer readable medium program codes performing functions includes a routine for receiving a frame, which contains a data packet, a network header portion and a transport layer header portion, at a SGW of a communication network. The computer readable medium further includes a routine for identifying a policy associated with the data packet using the information on the network header portion and on the transport layer header portion, a routine for determining a mode of transmitting the data packet to a destination in accordance with the entry, and a routine for encrypting the data packet if the mode of transmitting requires for the data packet to be secured using a security standard and/or protocol.

Another embodiment of the invention is a computer readable medium having computer readable program codes embodied therein for processing data packets. The computer readable medium program includes codes performing functions comprising a routine for receiving a frame having a secure data packet, which contains an encrypted inner data packet and an outer header portion, at a SGW of a communication network, a routine for incorporating a dual internal path at the SGW for processing the secure data packet, and a routine for using the information on the outer header portion to identify a policy associated with the secure data packet, the policy indicates a range of addresses. In the routine for incorporating the dual internal path, the secure data packet is routed through a first path or a second path of the dual internal path at the SGW.

Advantageously, by incorporating a dual path for processing secure data packets, normal secure data traffic (i.e., secure data traffic addressed to the PEP) is not slowed by additional work that may need to be performed to further process secure data traffic not addressed to the PEP. In addition, by retrieving a policy associated with a secure packet not addressed to the PEP and comparing a destination address and mask combination associated with the policy to a destination address in the secure packet to determine if the policy applies to the secure packet, the PEP is capable of processing secure packets that are not directly addressed to the PEP.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of a network that may implement the present invention.

FIG. 2 is a block diagram of a secure gateway (SGW) that may be used with the present invention.

FIG. 3 is a block diagram of a security association table (SAT) that may be used with the present invention.

FIG. 4 is a block diagram of a security association database (SAD) that may be used with the present invention.

FIG. 5 is a block diagram of the contents of a fast lookup content-addressable memory (CAM) that may be used with the present invention.

FIG. 6 is a block diagram of a security parameters database (SPD) that may be used with the present invention.

FIG. 7 is a block diagram of a layer-2 (L2) data frame that may be used with the present invention.

FIG. 8 is a block diagram of an Internet Protocol (IP) packet that may be used with the present invention.

FIG. 9 is a block diagram of an IP security (Ipsec) packet 800 that may be used with the present invention.

FIGS. 10A-B are a flowchart of a sequence of steps that may be used to process an outbound packet in accordance with an aspect of the present invention.

FIGS. 11A-D are a flowchart of a sequence of steps that may be used to process an inbound packet in accordance with an aspect of the present invention.

### DETAILED DESCRIPTION OF THE INVENTION

A description of preferred embodiments of the invention follows.

The following embodiments of the invention describe the invention as used with the Internet Protocol (IP), the User Datagram Protocol (UDP), the Transmission Control Protocol/IP (TCP/IP) and the IP security (IPsec) standard. A version of IP that may be used with the present invention is described in Request For Comments (RFC) 791, a version of UDP that may be used with the present invention is described in RFC 768, a version of TCP/IP that may be used with the present invention is described in RFC 793 and versions of the IPsec standard that may be used with the present invention are described in RFC 2401 through RFC 2412 and RFC 4301 through RFC 4309 all of which are available from the Internet Engineering Task Force (IETF) and all of which are hereby incorporated by reference as though fully set forth herein.

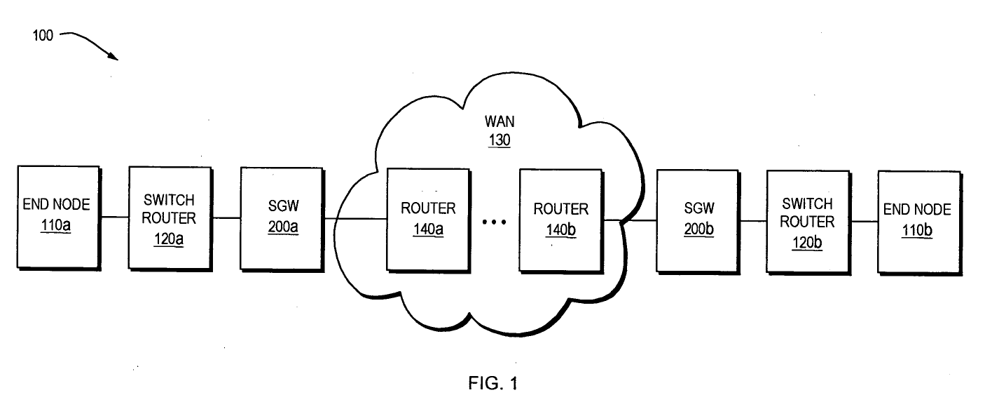

FIG. 1 is a block diagram of an exemplary communication network that may be used with the present invention. Network 100 comprises a plurality of nodes including end nodes 110, switch/routers 120, secure gateways (SGW) 200 and a wide-area network (WAN) 130 coupled via various data links to form an internetwork of nodes. These internetworked nodes communicate by exchanging data packets according to predefined protocols and standards, such as IP, TCP/IP, UDP and the IPsec standard.

The end nodes 110 are conventional nodes, such as personal computers, workstations, personal digital assistants (PDA) and the like. The switch/routers 120 are conventional switch/routers configured to interface the end nodes 110 with the SGWs 200. The WAN 130 is a conventional wide-area network, such as the Internet, that comprises one or more routers 140 configured to implement the WAN.

The SGWs 200 are secure gateways that act as policy enforcement points (PEPs) which are configured to process packets carried on the network 100 in accordance with aspects of the present invention. The SGWs 200 act as “bumps in the wire” meaning that they appear “transparent” to packets carried between the switch/routers 120 and routers 140.

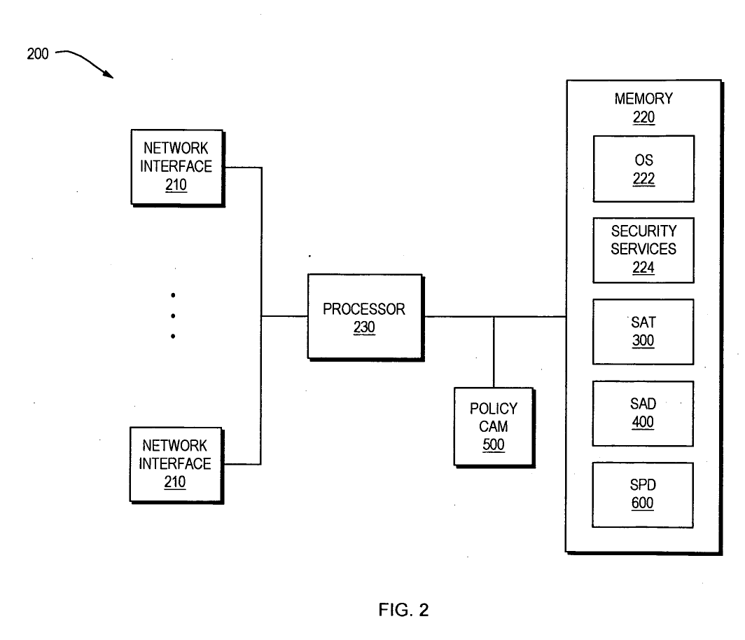

FIG. 2 is a high-level block diagram of an SGW 200 that may be used with the present invention. SGW 200 comprises one or more network interfaces 210, a processor 230, a policy content-addressable memory (CAM) 500 and a memory 220. The network interfaces 210 are conventional network interfaces configured to interface the SGW 200 with the network 100 and enable data (packets) to be transferred between the SGW 200 and the network 100. To that end, the network interfaces 210 comprise conventional circuitry that incorporates signal, electrical, and mechanical characteristics and interchange circuits, needed to interface with the physical media of the network 100 and the protocols running over that media.

The processor 230 is a conventional processor which is configured to execute computer-executable instructions and manipulate data in the memory 220 and the policy CAM 500. The processor 230 may be a network processing unit (NPU) or may comprise a collection of interconnected processors configured as a mesh or series of processors. The policy CAM 500 is a conventional CAM device that is configurable by processor 230 and, as will be described further below, contains information that the processor uses to process packets received by the SGW 200 in accordance with aspects of the present invention.

The memory 220 is a conventional random access memory (RAM) comprising, e.g., dynamic RAM (DRAM) devices. The memory 220 includes an operating system (OS) 222, security services 224, a security association table (SAT) 300, a security association database (SAD) 400 and a security policy database (SPD) 600. The operating system 222 is a conventional operating system that comprises computer-executable instructions and data configured to implement various conventional operating system functions that support the execution of processes, such as security services 224, on processor 230. These functions may include functions that, e.g., enable the processes to be scheduled for execution on the processor 230 as well as provide controlled access to various services, such as memory 220. The security services 224 is illustratively a process comprising computer-executable instructions configured to enable processor 230 to implement various functions associated with PEP's as well as perform functions that enable the processing of packets in accordance with aspects of the present invention.

The SAT 300 is a data structure that contains information that may be used to locate security associations associated with packets processed by the SGW 200. A security association, as used herein, relates to security information that describes a particular kind of secure connection between one device and another. This security information may include information that specifies particular security mechanisms that are used for secure communications between the two devices, such as encryption algorithms, type of authentication and the like.

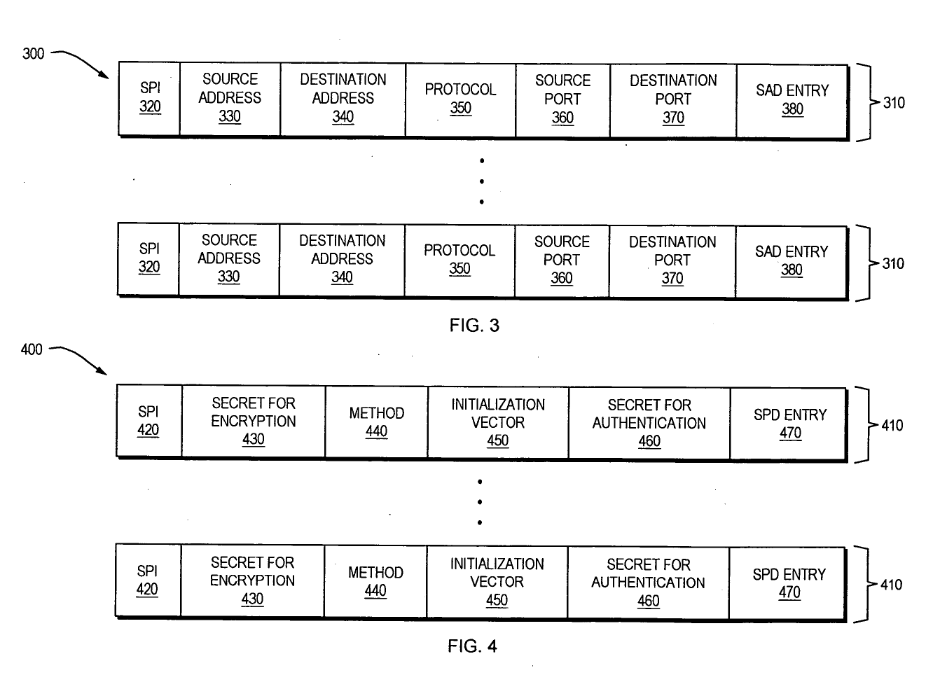

FIG. 3 is a block diagram of an SAT 300 that may be used with the present invention. SAT 300 is illustratively organized as a table containing one or more entries 310 wherein each entry 310 comprises a security parameters index (SPI) field 320, a source address field 330, a destination address field 340, a protocol field 350, a source port field 360, a destination port field 370 and a SAD entry field 380. The SPI field 320 holds a value that is used to associate the entry 310 with packets processed by the SGW 200. Likewise, the source address 330, destination address 340, protocol 350, source port 360 and destination port 370 fields hold information that is used to associate packets processed by the SGW 200 with the entry 310. Specifically, if the SPI contained in a packet matches the contents of the SPI field 320 of the entry 310, the entry 310 is associated with the packet. Similarly, if a layer-3 (L3) source address, destination address and protocol contained in the packet in combination with a layer-4 (L4) source port and destination port also contained in the packet match the source address 330, destination address 340, protocol 350, source port 360 and destination port 370, respectively, of an entry 310, the entry 310 is associated with the packet. As used herein, layer-2 (L2), L3 and L4 refer to the data link, network and transport layers of the Open Systems Interconnection Reference Model (OSI-RM), respectively. The SAD entry field 380 holds a pointer to an entry contained in the SAD 400.

The SAD 400 is a data structure that comprises security association information associated with packets processed by the SGW 200. FIG. 4 is a block diagram of an SAD 400 that may be used with the present invention. The SAD 400 is illustratively organized as a table comprising one or more entries 410 wherein each entry comprises an SPI field 420, a secret for encryption field 430, a method field 440, an initialization vector field 450, a secret for authentication field 460 and an SPD entry field 470. The SPI field 420 is configured to hold an SPI associated with packets processed by the SGW 200. The secret for encryption field 430 holds a secret which is used for encrypting and decrypting packets processed by the SGW 200 that are associated with the SPI 420. The method field 440 holds a value that represents a method used to encrypt/decrypt and authenticate the packets. The initialization vector (IV) holds a value that represents a conventional initialization vector associated with encrypting/decrypting the packets. The secret for authentication field 460 holds a conventional secret value that is used for authenticating packets associated with the SPI 420. The SPD entry field 470 holds a value that represents a pointer to an entry in the SPD 600 (described further below).

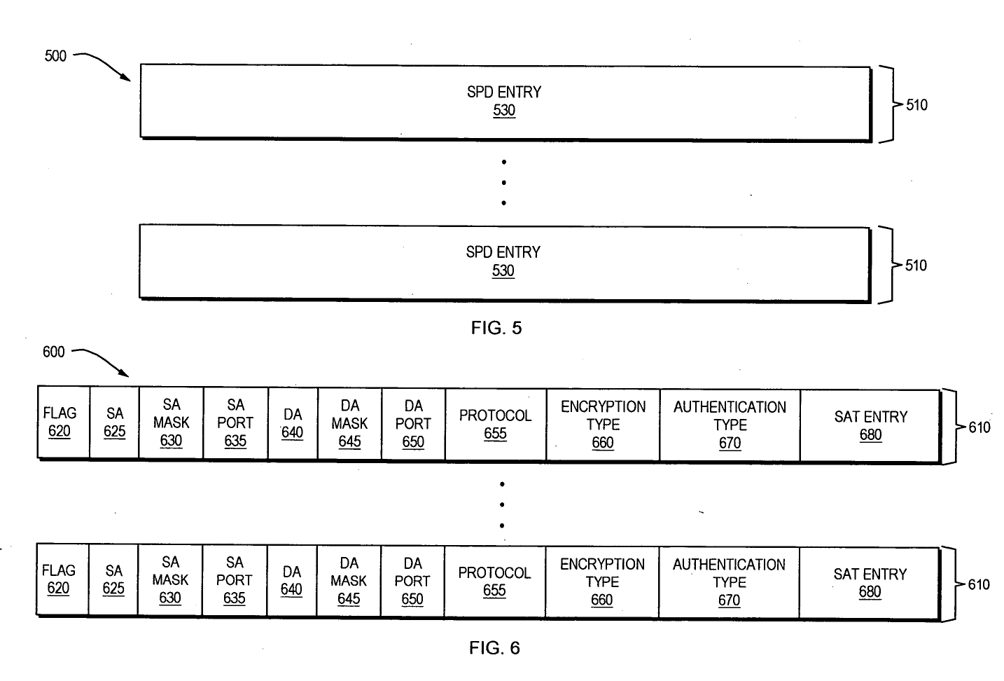

The policy CAM 500 is illustratively a high-speed lookup device that contains information that is used to locate entries in the SPD 600 for packets processed by the SGW 200. FIG. 5 is a block diagram of a policy CAM 500 that may be used with the present invention. Policy CAM 500 comprises one or more entries 510 wherein each entry 510 comprises an SPD entry field 530. The SPD entry field 530 holds a pointer to an entry in the SPD 600.

The entries 510 in the policy CAM 500 are selected using information contained in packets that are processed by the SGW 200. Illustratively, for each packet, this information includes an L3 destination address, L3 source address, L4 destination port and L4 source port contained in the packet. This information is applied to the policy CAM 500 to select an entry in the CAM 500. The contents of the SPD entry field 530 of the selected CAM entry points to an entry in the SPD 600 which holds information that represents a policy that, as will be described further below, is used to process the packet. It should be noted that in other embodiments of the invention, combinations of L2, L3 and L4 information contained in frames carrying packets processed by the SGW 200 are used to select entries 510 in the CAM.

The SPD 600 is a data structure that is configured to hold policy information that is applied to packets processed by the SGW 200. FIG. 6 is a block diagram of an SPD 600 that may be used with the present invention. SPD 600 is illustratively organized as a table comprising one or more entries 610 wherein each entry 610 represents a policy and comprises a flag field 620, a source address (SA) field 625, an SA mask field 630, an SA port field 635, a destination address (DA) 640, a DA mask field 645, a DA port field 650, a protocol field 655, an encryption type field 660, an authentication type field 670 and an SAT entry field 680. The flag field 620 holds a value that represents an indicator that indicates whether or not the entry 610 is to be used for processing inbound packets or outbound packets. Illustratively, if the flag field 620 is set to a value of 1, the entry 610 is to be used for processing inbound packets; otherwise, the entry is to be used for processing outbound packets.

The SA field 625, SA mask field 630, an SA port field 635, hold address, mask and port information, respectively, associated with a source of packets processed by the SGW 200. Likewise, the DA field 640, DA mask field 645, and DA port field 650 hold address, mask, and port information associated with a destination for packets processed by the SGW 200. The protocol field 655 holds protocol information associated with packets processed by the SGW 200. For IP packets, the protocol field 655 holds protocol information contained in the protocol fields contained in the IP headers of the IP packets (described further below). A selector used to select an entry 610 in the SPD 600 may comprise a combination of the flag 620, SA 625, SA mask 630, DA 640, DA mask 645 and the protocol 655 fields. A packet that contains information that matches the selector information contained in the entry 610 is said to be associated with the entry 610 and the policy indicated therein (e.g., encryption type, authentication type) is considered to apply to the packet.

The encryption type field 660 holds a value that represents a type of encryption, if any, that is used to encrypt/decrypt a packet that matches the selector information of the entry 610. Likewise, the authentication type field 670 holds a value that represents a type of authentication, if any, that is used to authenticate a packet that matches the selector information of the entry 610. Illustratively, for packets to be “sent in the clear” the encryption type field 660 and/or the authentication type field 670 are encoded to indicate that the packets are to be sent in the clear. The SAT entry field 680 holds a value that represents a pointer to an SAT entry 310 that is associated with a packet that matches the selector information of the entry 610.

It should be noted that functions performed by the SGW 200, including functions that implement aspects of the present invention, may be implemented in whole or in part using some combination of hardware and/or software. It should be further noted that computer-executable instructions and/or computer data that implement aspects of the present invention may be stored in various computer-readable mediums, such as volatile memories, non-volatile memories, flash memories, removable disks, non-removable disks and so on. In addition, it should be noted that various electromagnetic signals, such as wireless signals, electrical signals carried over a wire, optical signals carried over optical fiber and the like, may be encoded to carry computer-executable instructions and/or computer data that implement aspects of the present invention on, e.g., a communication network.

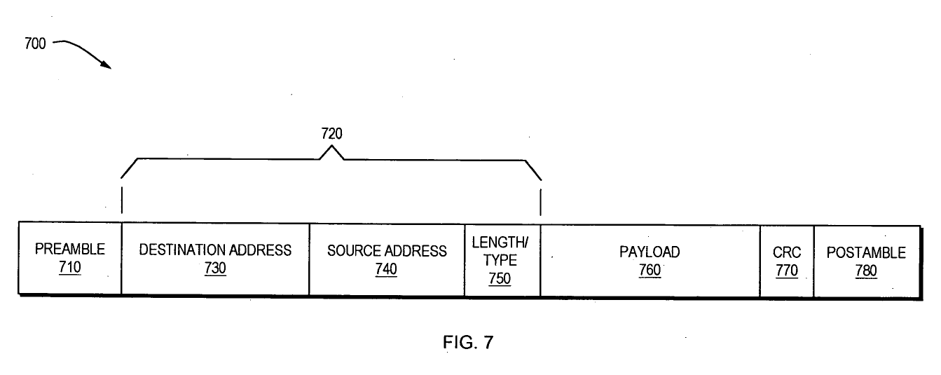

Illustratively, packets processed by an SGW 200 are carried at L2 layer in the network in L2 frames. FIG. 7 is a block diagram of an L2 frame 700 that may be used with the present invention. Frame 700 comprises a preamble field 710, a destination address field 730, a source address field 740, a length/type field 750, a payload field 760, a cyclic redundancy check (CRC) field 770 and a postamble field 780.

The preamble field 710 holds a bit pattern that is used by a receiver to synchronize reception of the frame 700. The destination address field 730 holds a value that represents an address of a destination for the frame 700. The source address field 740 holds a value that represents an address of an originator of the frame 700. The length/type field 750 holds a value that represents either a length of the frame 700 or a protocol type of the frame 700. Illustratively, if the value of this field 750 is less than or equal to 1,500, the field 750 indicates a length of the frame 700; otherwise, if the value of this field 750 is greater than or equal to 1,536, the field 750 indicates a protocol type of the frame 700 (e.g., Ethernet protocol type). The payload field 760 holds data that is transferred in the frame 700. This data may include an IP packet or an IPsec packet carried by the frame 700. The CRC field 770 holds a value that is used to error check the frame 700. The postamble field 780 holds a bit pattern that is used to indicate the end of the frame 700. The combination of the destination address 730, source address 740 and length/type 750 fields constitute an L2 header 720 of the frame.

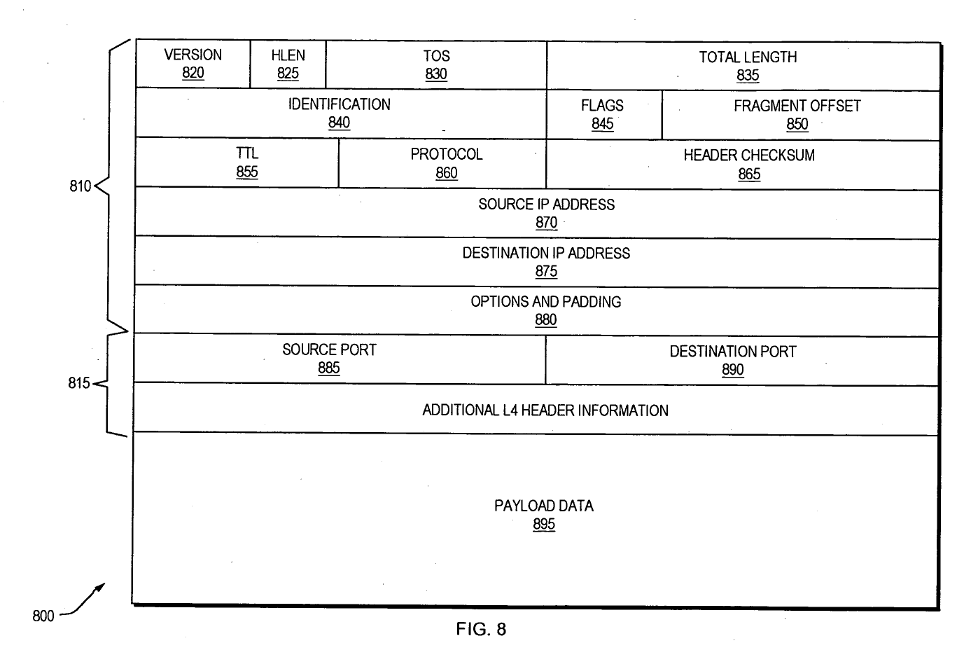

In network 100, the end nodes 110 may exchange information using IP packets. FIG. 8 is a block diagram of an IP packet 800 that may be used with the present invention. Packet 800 comprises a network layer header portion 810, a transport layer header portion 815 and a payload data portion 895. The payload data portion 895 holds user data transferred by the packet 800. The network layer header 810 comprises a version field 820, a header length (HLEN) field 825, a type-of-service (TOS) field 830, a total length field 835, an identification field 840, a flags field 845, a fragment offset field 850, a time-to-live (TTL) field 855, a protocol field 860, a header checksum field 865, a source IP address field 870, a destination IP address field 875 and an options and padding field 880.

The version field 820 specifies a value that represents a format of the IP packet header. Illustratively, this value is set to a value of 4 to indicate that the packet header is an IP version 4 (IPv4) type packet or to a value of 6 to indicate that the packet header is an IP version 6 (IPv6) type packet. The HLEN field 825 holds a value that represents a length of the IP packet header 810. The TOS field 830 holds a value that specifies various parameters associated with a type of service requested for the packet. The total length field 835 holds a value that represents a total length of the packet 800. The identification field 840 holds a value that is used to identify fragments of an IP packet associated with the header 810. The flags field 845 holds a value that represents various flags associated with the packet 800. The fragment offset field 850 holds a value that represents an offset value associated with a fragment of the packet 800 associated with the header 800. The TTL field 850 holds a value that represents a timer used to track the lifetime of the packet 800. The protocol field 860 holds a value that represents a protocol related to the packet 800. The header checksum field 865 holds a value that represents a checksum of the header 810. The source IP address field 870 holds a value that represents a source address associated with the packet 800. The destination IP address field 875 holds a value that represents a destination address associated with the packet 800. The options and padding field 880 holds information that represents various options associated with the packet 800 as well as padding information used to “pad out” the header 810 to guarantee that the transport layer portion 815 which follows the header 810 begins on a 32-bit boundary.

The transport layer header 815 comprises a source port field 885, a destination port field 890 and additional L4 header information field. The source port field 885 holds a value that represents a port of the sender of the packet 800. The destination port 890 holds a value that represents a destination port to which the packet is addressed. The additional L4 header information field contains additional L4 header information associated with the transport layer header 815. This information may include e.g., a length value, a checksum, sequence number, acknowledgement number and so on.

As used herein, IPsec packets refer to packets that are encoded in accordance with the IPsec standard. As noted above, the SGW 200 is configured to process IPsec packets received by the SGW 200 in accordance with aspects of the present invention. The IPsec packets are typically carried in the payload field 760 of frames 700 received and processed by the SGWs 200.

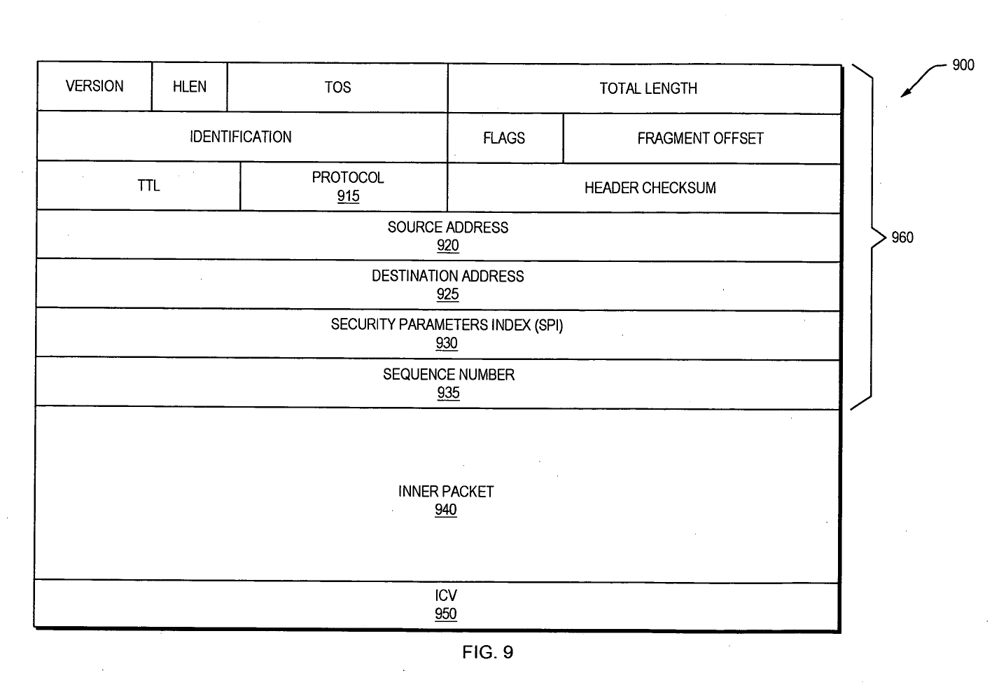

FIG. 9 is a block diagram of an IPsec packet 900 that may be used with the present invention. Packet 900 comprises an outer header portion 960, an inner packet portion 940 and an integrity check value (ICV) 950. The outer header 960 comprises a version field, a header length (HLEN) field, a type of service (TOS) field, a total length field, an identification field, a flags field, a fragment offset field, a time to live (TTL) field, a protocol field 915, a header checksum field, a source address field 920, a destination address field 925, a security parameters index (SPI) field 930 and a sequence number field 935. The version, HLEN, TOS, total length, identification, flags, fragment offset, TTL, protocol, checksum, source address and destination address fields hold information similar to the corresponding fields described above for the IP packet 800.

The SPI field 930 holds an identifier that may be used to identify a security association associated with the packet 900. The sequence number field 935 holds a value that illustratively is a monotonically increasing identifier that is used to assist in anti-replay protection. The inner packet portion 940 holds an IP packet 800 that is encapsulated within the IPsec packet 900. The ICV field 950 holds a value that may be used to verify the integrity of the packet 900 and ensure that the packet 900 has not been, e.g., damaged in transit or otherwise modified.

For IPsec packets, the protocol field 915 holds a value of 50 to indicate the packet is an IPsec encapsulating security payload (ESP) packet or a value of 51 to indicate the packet 900 is an IPsec authentication header (AH) type packet.

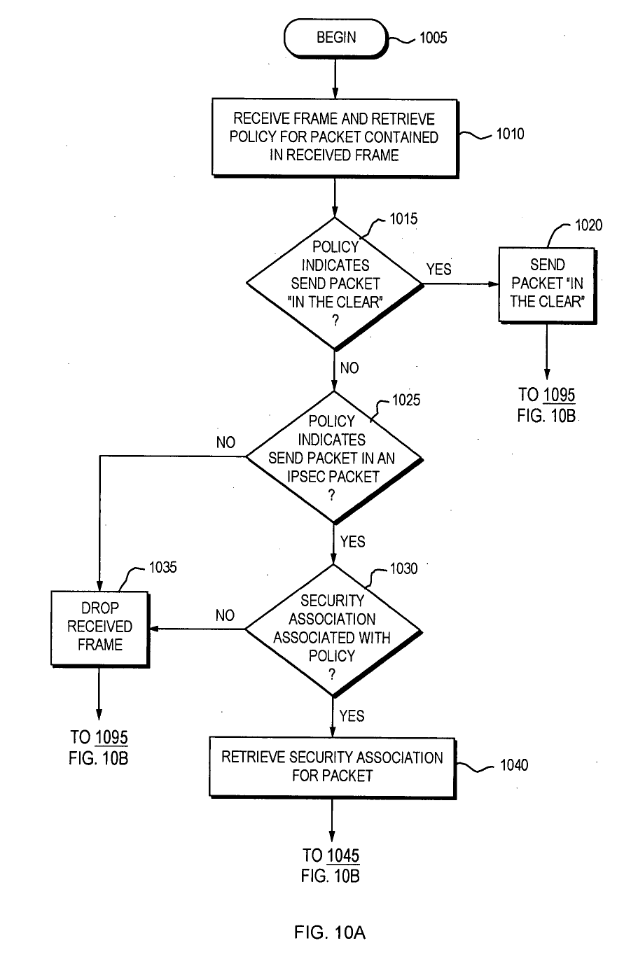

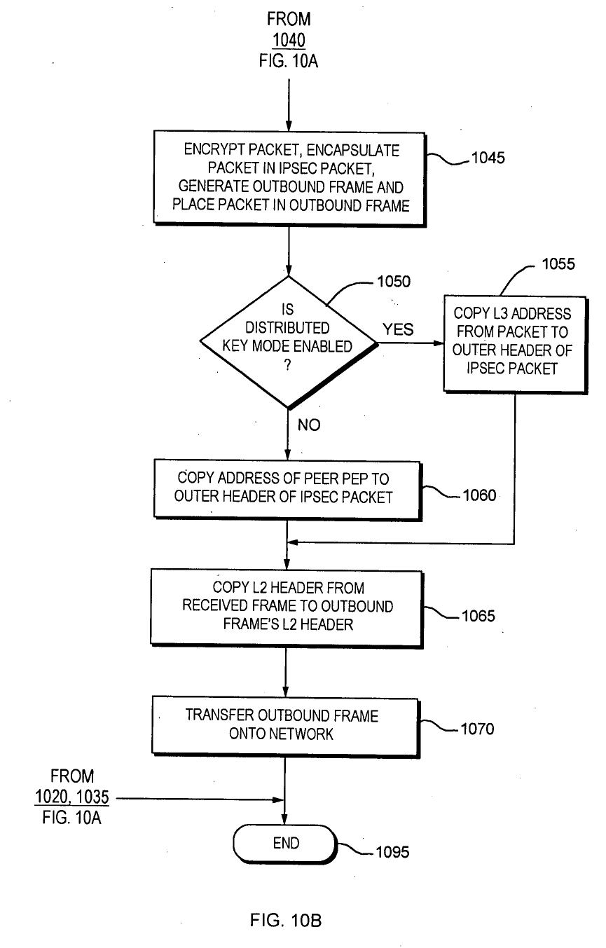

As noted above, the SGW's 200 are configured to perform various functions associated with PEP's as well as perform functions that enable the processing of packets in accordance with aspects of the present invention. FIGS. 10A-B are a flowchart of a sequence of steps that may be used to configure an SGW 200 to process an outbound packet 800 in accordance with an aspect of the present invention.

The sequence begins at step 1005 and proceeds to step 1010 where the SGW 200 receives a frame 700 containing the outbound packet 800 and retrieves a policy 610 for the packet 800. Illustratively, a check is performed to determine if the source address 870, destination address 875, protocol 860, source port 885 and destination port 890 contained in the packet 800 matches the range of addresses specified by the SA 625 and SA mask 630, the range of addresses specified by the DA 640 and DA mask 645, protocol 655, SA port 635 and DA port 650, respectively, of an entry 610 in the SPD 600. If so, the matching entry 610 is the policy that is retrieved for the packet 800.

Next, at step 1015, a check is performed to determine if the policy 610 indicates that the packet 800 should be sent “in the clear.” As used herein, sending a packet “in the clear” refers to sending a packet as it stands as opposed to encrypting and/or encapsulating the packet before sending it. If the packet is to be sent “in the clear”, the sequence proceeds to step 1020 where the packet is sent “in the clear” and step 1095 (FIG. 10B) where the sequence ends.

If at step 1015 the policy does not indicate that the packet should be sent “in the clear”, the sequence proceeds to step 1025 where a check is performed to determine if the policy indicates that the packet 800 should be sent in an IPsec packet 900. If not, the sequence proceeds to step 1035 where the packet 800 is dropped and step 1095. Otherwise, the sequence proceeds to step 1030 where a check is performed to determine if a security association is associated with the policy for the packet 800. If not, the sequence proceeds to step 1035. Otherwise, the sequence proceeds to step 1040 where the security association for the packet is retrieved.

Next, at step 1045 (FIG. 10B), the packet 800 is encrypted in accordance with the security association, it is encapsulated in an IPsec packet 900, an outbound frame 700 is generated and the IPsec packet 900 is placed in the payload portion of the outbound frame 700. At step 1050, a check is performed to determine if the SGW 200 is operating in a distributed key mode. Distributed key mode means that key information for packets (e.g., multicast packets, broadcast packets) is disseminated through the network 100 using a distributed key scheme. A distributed key scheme that may be used with the present invention is described in commonly owned U.S. Provisional Application 60/756,765 entitled “Securing Network Traffic Using Distributed Key Generation and Dissemination Over Secure Tunnels” by Donald McAlister which is hereby incorporated by reference in its entirety as though fully set forth herein.

If the SGW 200 is operating in distributed key mode, the sequence proceeds to step 1055 where the source 870 and destination addresses 875 from the L3 header 810 of the inner packet 940 are copied to the source address 920 and destination address 925, respectively, of the IPsec packet's outer header 960. The sequence then proceeds to step 1065. If at step 1050 the SGW 200 is not operating in distributed key mode, the sequence proceeds to step 1060 where an address associated with the SGW 200 is placed in the source address field 920 and an address of the peer SGW 200 is set in the destination address field 925 of the outer header 960 of the IPsec packet 900. At step 1065 the source 740 and destination 730 addresses in the L2 header 720 of the received frame 700 are copied to the source 740 and destination 730 fields, respectively, in the L2 header 720 of the outbound frame 700. At step 1070 the outbound frame 700 is transferred onto the network. The sequence then ends at step 1095.

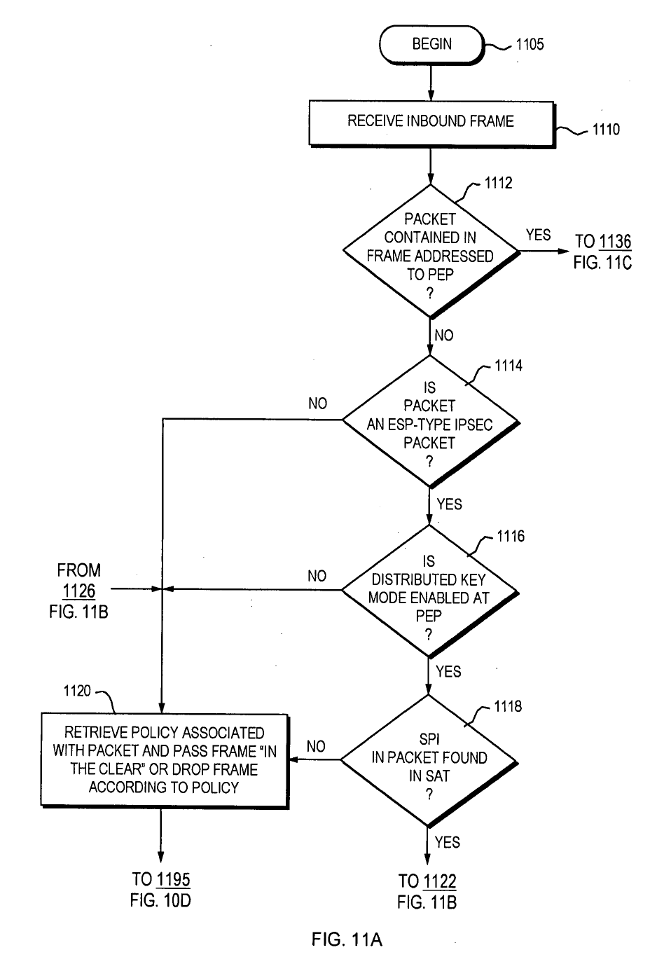

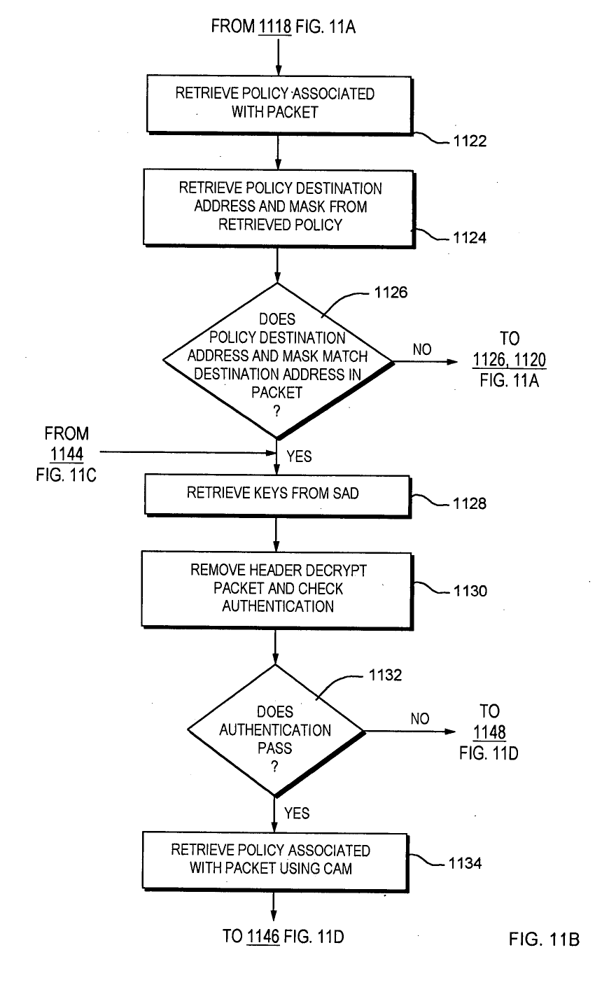

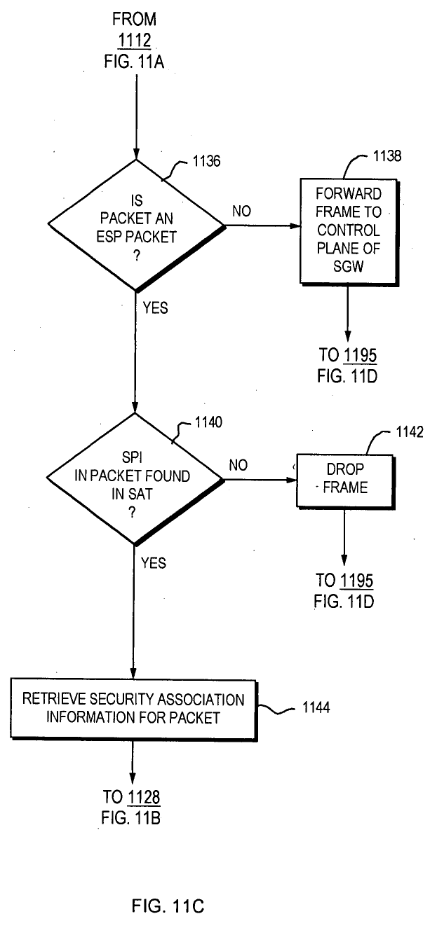

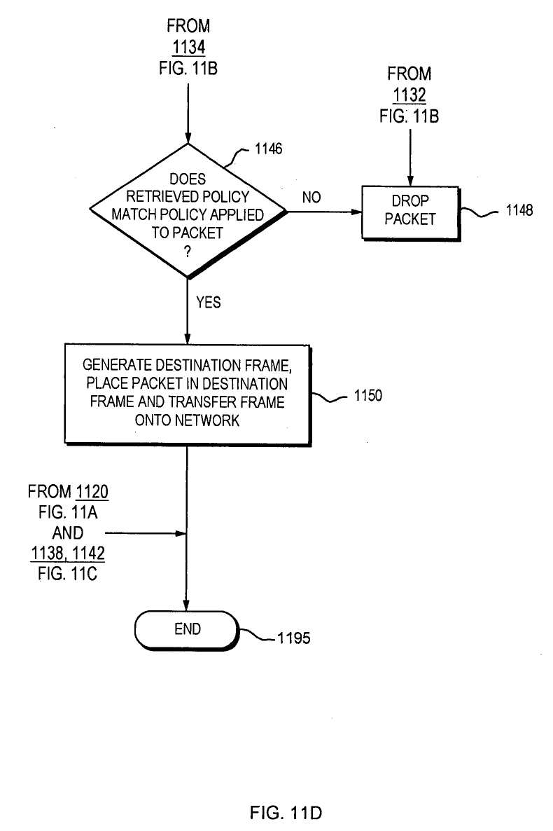

FIGS. 11A-D are a flowchart of a sequence of steps that may be used to configure an SGW 200 to process an inbound frame 700 received by the SGW 200 in accordance with an aspect of the present invention. The sequence begins at step 1105 and proceeds to step 1110 where the SGW 200 receives the inbound frame 700. At step 1112, the SGW 200 examines the frame 700 to determine if it contains a packet addressed to the PEP (SGW 200). If so, the sequence proceeds to step 1136 (FIG. 11C) where a check is performed to determine if the packet is an ESP-type IPsec packet 900. If not, the packet is assumed to be addressed to the control plane of the SGW 200 and the sequence proceeds to step 1138 where the packet is forwarded to the SGW's control plane and step 1195 (FIG. 11D) where the sequence ends. Otherwise, if at step 1136 the packet is an IPsec ESP-type packet 900, the sequence proceeds to step 1140 where a check is performed to determine if the SPI 930 contained in the packet 900 is found in the SGW's SAT 300. Illustratively, the SPI 930 is compared with the contents of the SPI field 320 of entries 310 contained in the SAT 300 to determine if the SPI 320 of an entry 310 matches the packet's SPI 930. If so, the SPI 930 is considered found in the SAT 300 and the matching entry 310 is associated with the packet 900.

If a matching entry 310 is not found in the SAT 300, the sequence proceeds to step 1142 where the received frame 700 is dropped and to step 1195 where the sequence ends. Otherwise, if a matching entry 310 is found, the sequence proceeds to step 1144 where the security association information associated with the packet 900 is retrieved from the SGW's SAD 400. Illustratively, the security association information is retrieved using the SAD pointer 380 contained in the matching entry 310 to access an entry 410 in the SAD 400. The security association information is retrieved from the accessed entry 410. The sequence then proceeds to step 1128 (FIG. 11B).

Returning to FIG. 11A, if at step 1112, the packet contained in the inbound frame 700 is not addressed to the PEP, the sequence proceeds to step 1114 where a check is performed to determine if the packet is an ESP-type IPsec packet 900. If not, the sequence proceeds to step 1120 where the SGW 200 retrieves the policy 610 associated with the packet and either passes the frame “in the clear” or drops it according to the retrieved policy. Illustratively, the policy for the packet is retrieved by locating an entry 610 whose selector matches information contained in the packet's L3 and L4 header, as described above. The sequence then proceeds to step 1195.

If at step 1114 the SGW 200 determines the packet is an ESP-type IPsec packet 900, the sequence proceeds to step 1116 where a check is performed to determine if the SGW 200 is operating in a distributed key mode, as described above. If not, the sequence proceeds to step 1120. Otherwise, the sequence proceeds to step 1118 where a check is performed to determine if the SPI 930 contained in the packet 900 is found in the SAT 300. Illustratively, this check is performed by comparing the SPI 930 with the contents of the SPI field 320 of entries 310 contained in the SAT 300 to determine if an entry 310 contains an SPI 320 that matches the packet's SPI 930. If so, the SPI 930 is considered found in the SAT 300. If the SPI 930 is not found in the SAT 300, the sequence proceeds to step 1120. Otherwise, the sequence proceeds to step 1122 (FIG. 11B) where the policy 610 associated with the packet 900 is retrieved from the SPD 600. Illustratively, the policy is retrieved by accessing the SAD entry 410 pointed to by the matching SAT entry's SAD entry 380 field. The contents of the SPD entry field 470 of the accessed entry 410 is used to retrieve the policy 610 from the SPD 600.

At step 1124, the SGW 200 retrieves a policy destination 610 address 640 and mask 645 from the retrieved policy 610. At step 1126, a check is performed to determine if the destination address 640 and mask 645 matches the destination address 925 contained in the packet 900. Illustratively, a match occurs if the destination address 925 falls within the range of destination addresses represented by the combination of the retrieved destination address 640 and mask 645. If at step 1126 the retrieved destination address 640 and mask 645 do not match the destination address 925 contained in the packet 900, the sequence proceeds to step 1120. Otherwise, the sequence proceeds to step 1128 where encryption and authentication key information 430, 460 associated with the packet 900 is retrieved from the SAD 400. Next at step 1130, the inner packet 940 is removed from the packet 900 and decrypted using the retrieved encryption key information 430 to reveal an IP packet 800. The IP packet 800 is then is authenticated using the retrieved authentication key information 460.

At step 1132, a check is performed to determine if the IP packet 800 is authentic. If not, the sequence proceeds to step 1148 (FIG. 11D) where the packet 800 is dropped. Otherwise, the sequence proceeds to step 1134 where the policy 610 associated with the packet 800 is retrieved. Illustratively, the policy 610 is retrieved, as described above, using the destination address 875 contained in the packet 800.

Next, at step 1146 (FIG. 11D), the SGW 200 performs a check to determine if the policy 610 that was retrieved for the packet 800 matches the actual policy 610 that was applied to the IPsec packet 900 to produce the packet 800. This check is performed to ensure that the correct policy has been applied to the IPsec packet 900 to produce the packet 800. If an incorrect policy has been applied, the sequence proceeds to step 1148 where the packet 800 is dropped. Otherwise, the sequence proceeds to step 1150 where a destination frame 700 is generated, the packet 800 is placed in the payload field of an destination frame 700, the destination address 730 and source address 740 in the L2 header 720 of the received frame 700 is placed in the destination address 730 and source address 740 of the L2 header 700 of the destination frame 700, respectively, and the destination frame 700 is forwarded onto the network 100 in a conventional manner. The sequence ends at step 1195.

For example, referring to FIGS. 1, 2, 10A-B and 11A-D, suppose that end node 110a has an IP packet 800 that is destined for end node 110b. Further, assume that the SGW's 200a-b are operating in distributed keymode and have distributed keys that are used to encrypt/decrypt and authenticate packets transferred between the end nodes 110a-b.

End node 110a places the IP packet 800 in a frame 700 and forwards the frame 700 to switch/router 120a. Switch/router 120a receives the frame 700 and processes it including determining that the destination for the IP packet 800 can be reached via router 140a. The switch/router 120a then replaces the destination address 730 contained in the frame 700 with the L2 address associated with router 140a and forwards the frame 700 towards router 140a.

SGW 200a receives the frame 700 and retrieves a policy for the IP packet 800 contained in the received frame 700 (step 1010), as described above. Specifically, the SGW 200a receives the frame 700 at a network interface 210 which transfers the frame 700 to the processor 230. The processor 230 uses L3 and L4 header information of the packet contained in the frame 700, as described above, to select an entry 510 in the policy CAM 500. The processor 230 then uses the SPD pointer 530 contained in the selected entry 510 to access (retrieve) an SPD entry 610 contained in the SPD 600 which contains the policy for the IP packet 800.

The processor 230 examines the retrieved SPD entry 610 to determine if the IP packet 800 should be transferred “in the clear” (step 1015). Assume that the IP packet 800 is not to be transferred “in the clear.” The processor 230 then examines the SPD entry 610 to determine if the IP packet 800 should be sent as an IPsec packet 900 (step 1025). Assume that the IP packet 800 should be sent as an IPsec packet 900.

The processor 230 then determines if there is a security association associated with the retrieved policy (step 1030). Specifically, the processor 230 examines the SAT entry field 680 of the retrieved SPD entry 610 and determines if it points to an SAT entry 310. If the SAT entry field 680 points to an entry 410, the processor 230 assumes that a security association is associated with the policy for the IP packet 800. Assume the retrieved policy is associated with a security association. The processor 230 then retrieves the security association for the packet (step 1040). Specifically, the processor 230 uses the pointer contained in the SAT entry field 680 of the retrieved SPD entry 610 to access an entry 310 in the SAT 300. The processor 230 uses the SAD entry 380 of the accessed entry 310 to access an SAD entry 410 in the SAD 400. The processor 230 then retrieves the secret for encryption 430, secret for authentication 440 and method 440 from the accessed SAD entry 410.

The processor 230 uses the encryption type 660 and authentication type 670 information from the SPD entry 610, and the method 440 and secret information 430 and 440 from the SAD entry 410 to encrypt the IP packet 800, accordingly. The processor 230 then encapsulates the encrypted IP packet 800 in accordance with the IPsec standard to produce an IPsec packet 900, generates an outbound frame 700 and places the IPsec packet 900 in the frame (step 1045). Specifically, the processor 230 allocates an IPsec packet 900 and outbound frame 700 in memory 220 and places the encrypted IP packet 800 in the inner packet field 940 of the allocated IPsec packet 900 in accordance with the IPsec standard. The processor 230 then places the IPsec packet 900 in the allocated outbound frame 700.

The processor 230 then determines if the SGW 200 is operating in distributed key mode (step 1050), as described above. As noted above, the SGW 200 is operating in distributed key mode, therefore, the processor 230 copies the L3 source 870 and destination 875 addresses of the IP packet 800 to the source 920 and destination 925 fields, respectively, of the IPsec packet 900 (step 1055). Next, the processor 230 copies the L2 header 720 of the received frame 700 to the L2 header 720 of the outbound frame 700 (step 1065). The processor 230 then transfers the outbound frame 700 onto the network via a network interface 210 (step 1070).

The frame 700 travels from SGW 200a to router 130a. Router 140a receives the frame 700, examines the destination address 925 contained in the packet 900 carried by the received frame 700 and determines that the packet 900 is destined for end node 110b. The router then forwards the packet 900 to the next hop in WAN 130 in a conventional manner. The packet 900 travels hop-by-hop through the WAN 130 and is eventually received at router 140b. Router 140b examines the destination address 925 of the packet 900 and determines that the packet is destined for end node 110b. Router 140b determines that the next hop to end node 110b is switch/router 120b. Router 140b generates a frame 700 containing the packet 900, places the L2 address of switch/router 120b in the destination address field 730 of the frame 700 and forwards the frame 700 to switch/router 120b.

The frame 700 is received by the SGW 200b as an inbound frame and processed accordingly. Specifically, the frame 700 is received by the SGW 200 at a network interface 210 and forwarded to the processor 230 (step 1110). The processor 230 checks the destination address 925 in the header 960 of the IPsec packet 900 contained in the frame 700 to determine if the packet 900 is addressed to the SGW 200 (step 1112). As noted above, the destination address 925 of the packet 900 is addressed to the end node 110b, therefore, the processor 230 proceeds to determine if the packet 900 is an ESP-type IPsec packet (step 1114). As noted above, the packet was encapsulated as an ESP-type IPsec packet, therefore the processor 230 proceeds to determine if distributed keymode is enabled at the SGW 200b (step 1116). As noted above, the distributed keymode is enabled at SGW 200B, therefore, the processor 230 determines if the SPI 930 contained in the packet 900 is found in the SAT 300 (step 1118).

Specifically, the processor 230 extracts the SPI 930 from the packet 900 compares it with the contents of the SPI field 320 of entries 310 in the SAT 300 to determine if the SPI 930 matches the contents of the SPI field 320 of an entry 310 in the SAT 300. Assume a matching entry 310 is found. The processor 230 then uses the SAD entry pointer 380 of the matching entry 310 to retrieve a policy 610 associated with the packet 900 from the SPD 600 (step 1122) and a destination address 640 and mask 645 from the retrieved policy (step 1124), as described above.

The processor 230 compares the retrieved destination address 640 and mask 645 with the destination address 925 in the packet 900 to determine if they match (step 1126), as described above. Assume the retrieved destination address 640 and mask 645 and the destination address 925 in the packet 900 match. The processor 230 retrieves the keys associated with the retrieved policy 610 from the SAD 400 (step 1128), as described above.

The processor then removes the outer header 960 from the packet 900, and decrypts the inner packet 940 to reveal the original IP packet 800 using the retrieved secret for encryption 430 and authenticates the IP packet 800 using the retrieved secret for authentication 440 (step 1130), as described above. Next, the processor 230 determines if the IP packet 800 is authentic (step 1132). Assume the packet 800 is authentic.

The processor 230 uses information contained in the authenticated packet 800 to retrieve a policy 610 from the SPD 600, as described above (step 1134). The processor 230 compares the retrieved SPD entry 610 with the SPD entry 610 used above to process the frame 700 to determine if they match. Assume the policies match. The processor then places the packet 800 in a frame 700 and forwards the frame 700 onto the network 100 to end node 110b, as described above (step 1150).

While this invention has been particularly shown and described with references to preferred embodiments thereof, it will be understood by those skilled in the art that various changes in form and details may be made therein without departing from the scope of the invention encompassed by the appended claims.

1. A method for processing data packets, the method comprising the steps of:
receiving a first frame at a secure gateway of a communication network, the first frame containing a data packet, a first network header portion and a first transport layer header portion;
identifying a policy associated with the data packet using the information on the first network header portion and on the first transport layer header portion;
determining a mode of transmitting the data packet to a destination in accordance with the entry; and
if the mode of transmitting requires for the data packet to be secured using a security standard and/or protocol, encrypting the data packet.

2. The method of claim 1, wherein the step of identifying a policy using the information on the first network header portion and on the first transport layer portion header portion includes retrieving the policy

3. The method of claim 1, wherein if the mode of transmitting requires for the data packet to be secured using a security standard and/or protocol, encrypting the data packet according to the policy.

4. The method of claim 1 further including, if the mode of transmitting requires for the packet to be secured using a security standard and/or protocol, encapsulating the encrypted data packet and producing an IPsec packet, the IPsec packet including an outer header portion.

5. The method of claim 4 further including generating an outbound frame and placing the IPsec packet in the outbound frame.

6. The method of claim 5, wherein if a distributed key mode is operating, the secure gateway copies the information on the first network header portion and on the first transport layer portion of the data packet to the outer header portion of the IPsec packet.

7. The method of claim 5 further includes a step of transmitting the outbound frame via one or more routers, wherein the one or more routers generate a second frame containing the IPsec packet, the second frame having a second network header portion and a second transport layer portion.

8. A method for processing data packets, the method comprising:
receiving a frame having a secure data packet at a secure gateway of a communication network, the secure data packet containing an encrypted inner data packet and an outer header portion;
incorporating a dual internal path at the secure gateway for processing the secure data packet, the secure data packet is routed through a first path or a second path of the dual internal path at the secure gateway; and
using the information on the outer header portion to identify a policy associated with the secure data packet, the policy indicating a range of addresses.

9. The method of claim 8, wherein the encrypted inner data packet is an IPsec packet.

10. The method of claim 8, wherein the routing of the frame is determined by the information on the outer header portion of the frame.

11. The method of claim 10, wherein the information on the outer header portion includes a security parameter index (SPI) and a destination address.

12. The method of claim 8, wherein:
the first path processes the frame with an address directed to the secure gateway; and
the second path processes the frame with an address not directed to the secure gateway.

13. The method of claim 8, wherein operating a dual internal path at the secure gateway for processing the secure data packet includes determining if the secure gateway is operating a distributed key mode.

14. The method of claim 8 further including retrieving a policy of the secure gateway associated the secure data packet if the information on the outer header portion matches with the policy, wherein the information is a SPI.

15. The method of claim 14 further including the steps of:
a) decrypting the encrypted inner data packet if the destination address matches the range of addresses; and
b) authenticating the decrypted inner data packet.

16. The method of claim 9 further including generating a destination frame for the decrypted inner data packet to be forwarded onto a destination.

17. A security gateway in a communication network comprising:
a module receiving a frame at a secure gateway of a communication network, the frame containing a data packet, a network header portion and a first transport layer header portion; and
a processor for:
a) identifying a policy associated with the data packet using the information on the first network header portion and on the first transport layer header portion;
b) determining a mode of transmitting the data packet to a destination in accordance with the entry; and
c) if the mode of transmitting requires for the data packet to be secured using a security standard and/or protocol, encrypting the data packet.

18. A security gateway in a communication network comprising:
a module receiving a frame having a secure data packet at a secure gateway of a communication network, the secure data packet containing an encrypted inner data packet and an outer header portion; and
a processor for:
a) incorporating a dual internal path at the secure gateway for processing the secure data packet, the secure data packet is routed through a first path or a second path of the dual internal path at the secure gateway; and
b) using the information on the outer header portion to identify a policy associated with the secure data packet, the policy indicating a range of addresses.

19. The security gateway of claim 18, wherein the processor includes a security association table.

20. The security gateway of claim 18 further including a data structure configured to hold policy information that is applied to the secure data packet.

21. A computer readable medium having computer readable program codes embodied therein for processing data packets, the computer readable medium program codes performing functions comprising:
a routine for receiving a frame at a secure gateway of a communication network, the frame containing a data packet, a network header portion and a transport layer header portion;
a routine for identifying a policy associated with the data packet using the information on the network header portion and on the transport layer header portion;
a routine for determining a mode of transmitting the data packet to a destination in accordance with the entry; and
a routine for, encrypting the data packet if the mode of transmitting requires for the data packet to be secured using a security standard and/or protocol.

22. A computer readable medium having computer readable program codes embodied therein for processing data packets, the computer readable medium program codes performing functions comprising:
a routine for receiving a frame having a secure data packet at a secure gateway of a communication network, the secure data packet containing an encrypted inner data packet and an outer header portion;
a routine for incorporating a dual internal path at the secure gateway for processing the secure data packet, the secure data packet is routed through a first path or a second path of the dual internal path at the secure gateway; and
a routine for using the information on the outer header portion to identify a policy associated with the secure data packet, the policy indicates a range of addresses.
